(19) United States
(12) Patent Application Publication
(10) Pub. No.: US 2018/0361537 A1
(43) Pub. Date: Dec. 20, 2018

(54) SYSTEM FOR DRY CLEANING OF FOOD PROCESSING EQUIPMENT UTILIZING SALT PARTICLES OF SODIUM CARBONATE, SODIUM BICARBONATE AND CALCIUM PHOSPHATE AND METHODS OF DRY CLEANING USING THE SAME

(71) Applicant: IPCO Sweden AB, Sandviken (SE)

(72) Inventor: Fabio MARCONI, Corciano Perugia (IT)

(73) Assignee: IPCO Sweden AB, Sandviken (SE)

(21) Appl. No.: 15/776,799

(22) PCT Filed: Nov. 21, 2016
(86) PCT No.: PCT/EP2016/078350

§ 371 Date: May 17, 2018

Related U.S. Application Data
(60) Provisional application No. 62/257,439, filed on Nov. 19, 2015.

(51) Int. Cl. B24C 1/08; B08B 7/02; B24C 9/00; B24C 11/00; B24C 7/00

(52) U.S. Cl. CPC B24C 1/086; B08B 7/02; B24C 7/0046; B24C 11/00; B24C 9/006

(57) ABSTRACT

Cleaning systems for food-related equipment and surfaces, such as, but not limited to, a steel belt baking surface, has a translatable and pivotable arm to position a discharge manifold over a surface to be cleaned. The arm has supply and return lines for a salt composition that includes one or more of sodium carbonate, sodium bicarbonate and calcium phosphate and does not include a liquid component. The salt impinges the surface and kinetically and chemically cleans it. Discharged salt is collected by drawing the salt through the return line and to a filter unit. The translatable and pivotable arm can be composed of telescoping sections forming a telescoping conduit for the return line or can be composed of non-telescoping sections that form the return line. The cleaning system operates in an open loop mode.

### FIELD OF THE DISCLOSURE

The present disclosure relates to cleaning systems for food-related equipment like, but not limited to, conveyors, freezers, dryers, bake ovens, coolers, steam cookers, and surfaces such as, but not limited to, solid belts, perforated belts, wire-mesh belts and plates. More specifically, the present disclosure relates to an apparatus and associated methods for continuous and automatic cleaning of food-related equipment and surfaces, such as conveyors, baking surfaces and heating surfaces of food processing equipment, by one or more of kinetic impingement of and chemical reaction with particles having a composition including one or more of sodium bicarbonate, sodium carbonate and calcium phosphate in a dry cleaning process, i.e., a process that does not include a separate liquid component.

### BACKGROUND

In the discussion that follows, reference is made to certain structures and/or methods. However, the following references should not be construed as an admission that these structures and/or methods constitute prior art. Applicant expressly reserves the right to demonstrate that such structures and/or methods do not qualify as prior art against the present invention.

Food-related equipment and surfaces, such as conveyors, baking surfaces and heating surfaces of food processing equipment, contact food products during preparation and cooking and, subsequently, during handling and packaging. However, during these processes the surfaces of the food-related equipment and surfaces are dirtied, soiled or contaminated by residual food material or the reaction of food processing by-products with the food processing equipment, which, in turn, increases the possibility of contamination of food products. Accordingly, such baking surfaces and heating surfaces of food processing equipment require cleaning, sterilization and/or replacement at suitable intervals to allow for continued safe and effective production of food products.

Typically, the food processing industry uses caustic soda to clean effected surfaces. Alternatively, other acids or dry ice systems with high pressure and/or temperature are used for this cleaning purpose. In either of these cases, the process can be dangerous for employers and/or the environment, and/or corrodes or wears the surfaces and parts being cleaned.

### SUMMARY

It would be advantageous to obtain the necessary levels of cleanliness for conveyors, baking surfaces and heating surfaces of food processing equipment without the detrimental ancillary effects of the currently used methods and products.

In place of the currently used methods and products, a system and method for cleaning food processing equipment has been developed that impacts the surfaces to be cleaned with particles of salt in an environment that does not include a separate liquid component, i.e., a dry environment. The composition of the particles of salt are a combination of one or more of sodium carbonate (Na₂CO₃), sodium bicarbonate (NaHCO₃) and calcium phosphate (which can be one or more of monocalcium phosphate (Ca(H₂PO₄)₂), dicalcium phosphate (CaHPO₄) and tricalcium phosphate (Ca₃(PO₄)₂)). The salt cleans the surface of the equipment, preferably a steel belt-based equipment, both mechanically, by impacting the surface at high speed, and chemically, by reacting the salt with residues on the surface, and without eroding the surface.

In general, a cleaning system comprises an applicator unit, a modular arm unit with an extensible arm, a buffer unit, a filter unit, a vacuum or suction unit, and associated connection hoses.

An exemplary embodiment of a cleaning system to mechanically impact a surface with a plurality of salt particles comprises an applicator unit, a filter unit, and a vacuum unit, wherein the applicator unit includes a modular arm unit with an extensible arm and a buffer unit, wherein the extensible arm includes a plurality of sections forming a telescoping conduit, an application head at a first longitudinal end of the arm, and an outlet at a second longitudinal end of the arm for operable connection to the filter unit, wherein sections of the telescoping conduit are translatable relative to the second longitudinal end in a longitudinal direction along a guide arm, wherein the application head includes a containment hood enclosing an interior volume and having a base end in operable connection with the outlet at the second longitudinal end of the arm via a passage including the telescoping conduit, a distal end having an opening to the interior volume, and a discharge manifold having an inlet port at an inlet end in operable connection to a storage volume for the plurality of salt particles, an array of discharge ports at a discharge end, and a plurality of discharge lines in operable communication with the inlet port and the array of discharge ports, and wherein the applicator unit, the filter unit, and the vacuum unit are connectable to draw the plurality of salt particles exiting the discharge manifold of the application head of the applicator unit to the filter unit.

Another exemplary embodiment of a cleaning system to mechanically impact a surface with a plurality of salt particles comprises an applicator unit, a filter unit, and a vacuum unit, wherein the applicator unit includes a positioning support structure including an arm with a conduit connecting an application head at a first longitudinal end of the arm to an outlet at a second longitudinal end of the arm for operable connection to the filter unit, wherein the arm is supported on a guide arm support base by a plurality of mounting structures and is longitudinally translatable relative to the guide arm support base, wherein the application head includes a containment hood enclosing an interior volume and having a base end in operable connection with the conduit, a distal end having an opening to the interior volume, and a discharge manifold having an inlet port at an inlet end in operable connection to a storage volume for the plurality of salt particles, an array of discharge ports at a discharge end, and a plurality of discharge lines in operable communication with the inlet port and the array of discharge ports, and wherein the applicator unit, the filter unit, and the vacuum unit are attachable to draw the plurality of salt particles exiting the discharge manifold of the application head of the applicator unit to the filter unit.

An exemplary method of cleaning a surface of food-related equipment with a cleaning system comprises positioning the arm of the applicator unit to locate the opening in the distal end of the containment hood of the application head over the surface of food-related equipment to be cleaned, wherein positioning includes one or more of translating the telescoping sections, translating the non-telescoping conduit, and pivoting the positioning support structure so that the surface to be cleaned is located within an impact zone of the salt exiting the array of discharge ports of the discharge manifold, sealing the impact zone by positioning the surface of the distal end of the containment hood relative to the surface to be cleaned so that a suction can be drawn on an interior volume of the containment hood, sending salt through the supply line to the discharge manifold, discharging salt from the discharge manifold to impinge the surface to be cleaned located in the impact zone, and collecting the discharged salt in the filter unit by applying a suction to the interior volume of the containment hood to draw the discharged salt through the telescoping or non-telescoping conduit and to the filter unit.

### BRIEF DESCRIPTION OF THE DRAWING

The following detailed description of preferred embodiments can be read in connection with the accompanying drawings in which like numerals designate like elements and in which:

FIG. 1 shows a perspective view of an exemplar cleaning system showing an applicator unit, a modular arm unit with an extensible arm, a buffer unit, a filter unit, a vacuum or suction unit, and associated connection hoses.

FIG. 2 shows a perspective, overhead view of a portion of the a modular arm unit with an extensible arm, applicator unit, and buffer unit from FIG. 1 positioned relative to food processing equipment.

FIGS. 3A and 3B show schematic illustrations of an embodiment of an exemplar arm of a modular arm unit with an extensible arm and an exemplar positioning support structure in a side view (FIG. 3A) and a top view (FIG. 3B).

FIG. 4 is a schematic perspective illustration in partial cut-away view of the exemplar modular arm unit with an extensible arm and the exemplar positioning support structure shown in FIGS. 3A and 3B.

FIGS. 5A and 5B are schematic illustrations of a first exemplar application head of an extensible arm in perspective view (FIG. 5A) and partial cut-away perspective view (FIG. 5B).

FIGS. 6A and 6B are schematic illustrations of a second exemplar application head of an extensible arm in perspective view (FIG. 6A) and cut-away side view (FIG. 6B).

FIGS. 7A to 7D are schematic illustrations of an exemplar first discharge manifold showing a perspective side view (FIG. 7A), a cut-away side view (FIG. 7B), an inlet end view (FIG. 7C) and discharge end view (FIG. 7D).

FIGS. 8A to 8D are schematic illustrations of an exemplar second discharge manifold showing a perspective side view (FIG. 8A), a cut-away side view (FIG. 8B), an inlet end view (FIG. 8C) and discharge end view (FIG. 8D).

FIG. 9 is an exploded, perspective view of an exemplary embodiment of a discharge manifold.

FIGS. 10A and 10B are schematic illustrations of an exemplar positioning support structure showing a perspective view (FIG. 10A) and a top view (FIG. 10B).

FIGS. 11A and 11B are schematic illustrations of an exemplar positioning support structure from FIGS. 10A and 10B with a modular arm unit with an extensible arm and an application head in a perspective view (FIG. 11A) and a top view (FIG. 11B).

FIG. 12 is a schematic illustration of a perspective view of an exemplar filter unit and an exemplar vacuum unit.

FIG. 13 is a schematic, side elevation view of an exemplar cleaning system showing the arrangement of the cleaning system relative to a surface to be cleaned and a collection means to collect used salt composition and residues from cleaning.

### DETAILED DESCRIPTION

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

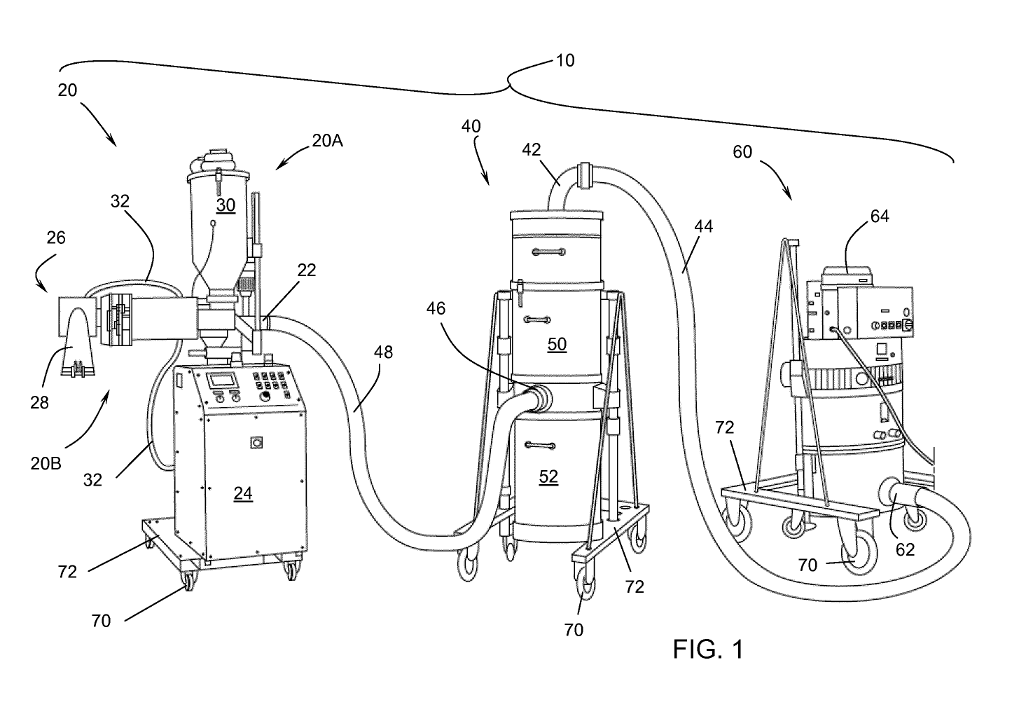

FIG. 1 illustrates an exemplar cleaning system 10. The exemplar cleaning system 10 includes an applicator unit 20, a filter unit 40 and a vacuum unit 60. The applicator unit 20 includes a buffer unit 20A and a modular arm unit 20B with an extensible arm having an application head or hood. FIG. 1 shows an example arrangement of the components of the cleaning system 10 in which an outlet 42 of the filter unit 40 is operably connected by a first hose or tubing 44 to an inlet 62 of vacuum unit 60 and an inlet 46 of the of the filter unit 40 is operably connected by a second hose or tubing 48 to an outlet 22 of the applicator unit 20.

The vacuum unit 60 includes a vacuum motor 64 or similar device that creates a reduced pressure that is connected through the first hose or tubing 44, to a first chamber 50 of the filter unit 40 resulting in a suction in the applicator unit 20 that draws the salt applied by the applicator unit 20 through the second hose or tubing 48 and into the filter unit 40. Internally to the filter unit 40, the outlet 42 is separated from the inlet 46 by a tortuous path or a mechanical filter that allows the atmosphere to be drawn through the first hose or tubing 44 to an inlet 62 of vacuum unit 60 while salt entrained in the flow of the atmosphere is removed from the atmosphere and is collected, typically assisted by gravity, into the second chamber 52 of the filter unit 40. The vacuum unit 60 also includes a filter system, such as a group of ULPA filters (H14/U15 with efficiency 99.99971% up to 0.12 μm), which does not allow residual particles coming from the filter unit 40 to return or to spread into the room.

The movement of salt through the system 10 is in an open loop. Salt is supplied to a salt supply volume or a port in the applicator unit 20. Salt is launched by compressed air from a launch unit 24 portion of the applicator unit 20, which supplies the salt through a supply line 32 to a discharge manifold in an application head 26 of the extensible arm 80 (see following figures) of the modular arm unit 20B where the salt is impinged against the surface to be cleaned. The compressed air is either supplied from a source external to the applicator unit 20, e.g., through suitable connections, or supplied from a compressed air source internal to the applicator unit, e.g., a compressed air storage vessel in the launch unit 24. An optional containment hood 28 encloses the discharge manifold to constrain the salt from the discharge manifold to an impact zone where the salt impacts the surface to be cleaned at high speed, typically about 800 km/h at 4-6 bars. After impacting the surface to be cleaned, the salt (with any removed residues) is collected by the vacuum unit 60 together with the filter unit 40. When solid surfaces, like solid steel belts, are cleaned, the whole quantity of salts and residues is collected from the top of the surface by the vacuum action of the vacuum unit 60; when non-solid surfaces, like perforated belts or wire-mesh belts, are cleaned, nominally one third of salts and residues are collected from the top of the surface by the vacuum action of the vacuum unit 60 and nominally two thirds are collected by suitable means, e.g., by a collection trough below the surface to be cleaned.

In the exemplar embodiment of FIG. 1, the applicator unit 20 includes a storage tank (not shown) within the launch unit 24 that is connected to a buffer tank 30 that contains the salt supply volume. The salt is supplied through a supply line 32 (such as a hose) to a discharge manifold in an application head 26, where the salt is impinged against the surface to be cleaned. Compressed air or other suitable means can be used to provide the motive force for the salt and to force the salt through the supply line 32. For example a source of compressed air can be connected to a connection to thereby provide the compressed air to the storage tank and/or to the buffer tank 30. A containment hood 28 enclosing the discharge manifold and constraining the impact zone of the salt is in operable connection to the outlet 22 of the applicator unit 20 such that the suction applied to the applicator unit 20 draws the salt from the impact zone through suitable passages or conduits in the modular arm unit 20B of the application unit 20 to the outlet 22 and through the second hose or tubing 48 and into the filter unit 40, where it is collected in the second chamber 52, for example in bags internal to the second chamber 52.

The components of the cleaning system 10 can be mounted together or separately for ease of movement and locating of components about equipment such as food processing equipment. Additionally or alternatively, the components of the cleaning system 10 can include wheels 70 attached to the components directly or to a base 72 of the individual or collectively mounted components to further facilitate the movement and locating of the components.

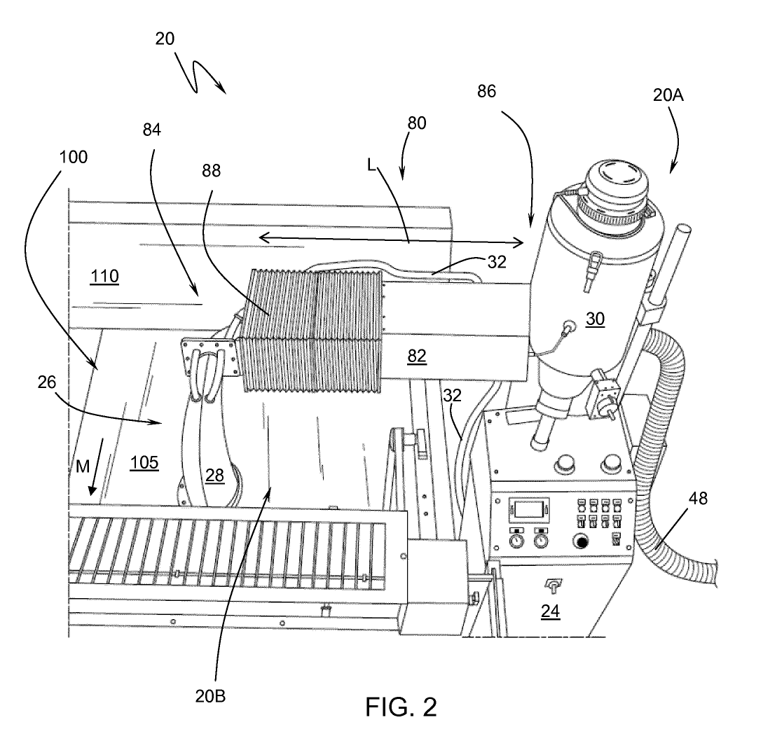

FIG. 2 shows a perspective, overhead view of a portion of the exemplar applicator unit 20 from FIG. 1 positioned relative to food processing equipment 100. The applicator unit 20 includes a positioning support structure (located behind the buffer tank 30 in the FIG. 2 view) and the extensible arm 80 with a housing 82. The application head 26 with the containment hood 28 is at a first longitudinal end 84 of the extensible arm 80 and second longitudinal end 86 is adjustably fixed to the positioning support structure. The extensible arm 80 is translatable relative to the second longitudinal end 86 of the arm 80 and to the positioning support structure in a longitudinal direction (L) along the longitudinal axis of the extensible arm 80. Internal to the housing 82, the extensible arm 80 includes the internal passages to connect the internal volume of the containment hood 28 enclosing the discharge manifold and constraining the impact zone of the salt to the outlet 22 of the applicator unit 20 such that the suction applied to the applicator unit 20 draws the salt from the impact zone. A portion of the housing 82 includes a bellows 88 that can extend and retract commensurate with the longitudinal translation of the arm 80. The supply line 32 is shown external to the housing 82. The supply line 32 extends from the launch unit 24 (which supplies compressed gas to the force the salt composition through the supply line 32 and which provides motive force to the salt composition) along the extensible arm 80 to the first longitudinal end 84 and is connect to an inlet of the application head 26. The supply line 32 includes suitable coiling or other features to accommodate extension and retraction of the arm 80 in the y-direction (relative to the orthogonal frame of reference 130) while providing operable connection to supply salt to application head 26 at the desired pressure and volume. In the FIG. 2 view, the second hose or tubing 48 is shown connected to the outlet 22 of the applicator unit 20 (and is in operable connection to the filter unit 40).

As an example and as shown in FIG. 2, a portion of the food processing equipment 100 includes a steel belt 105 that functions as the cooking or baking surface for food processed by the equipment. The steel belt 105 is arranged as a continuous belt in the food processing equipment 100 and is shown exiting the heating equipment 110. The cleaning system 10 can be positioned at the exit or entrance of the cooking/baking equipment.

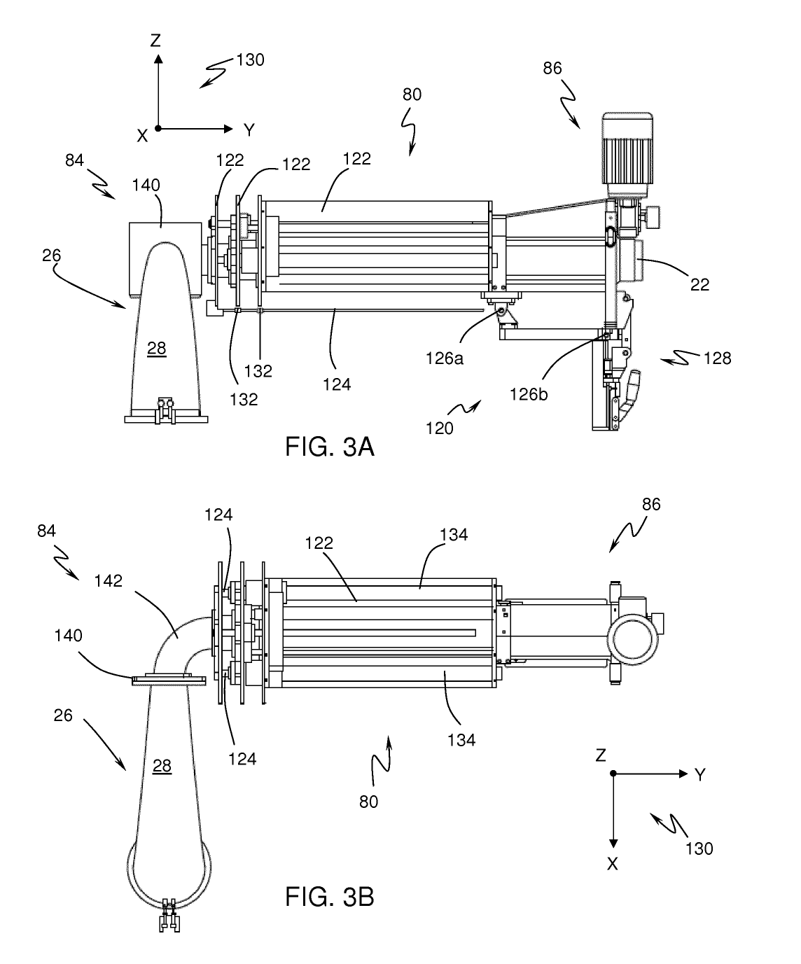

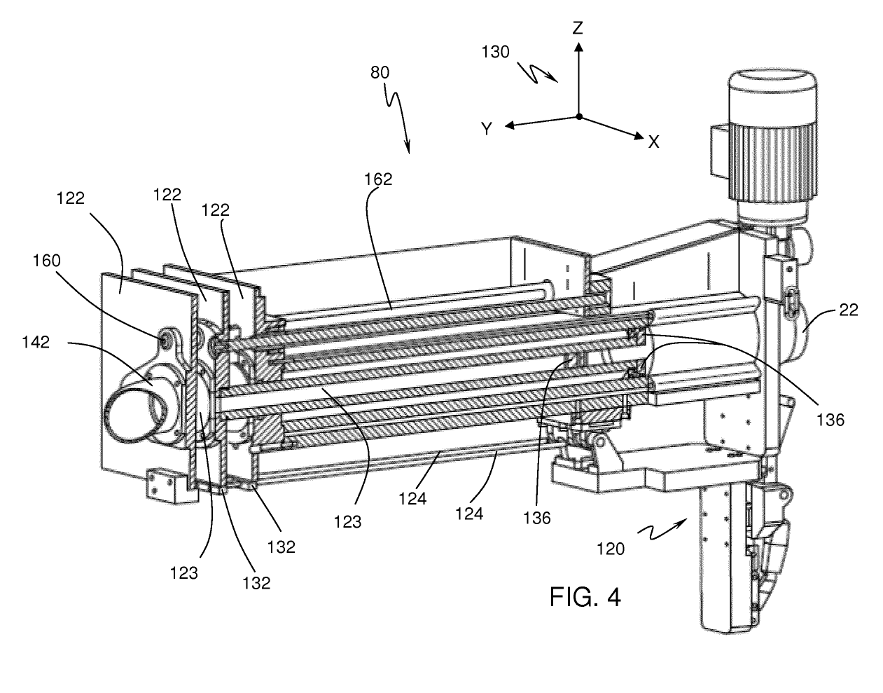

FIGS. 3A and 3B show schematic illustrations of an embodiment of an exemplar extensible arm 80 of the modular arm unit 20B of an applicator unit 20 and showing the exemplar positioning support structure 120 in a side view (FIG. 3A) and a top view (FIG. 3B). The extensible arm 80 has an application head 26 with a containment hood 28 at a first longitudinal end 84, a plurality of telescoping sections 122 forming a telescoping conduit 123 (see FIG. 4), one or more guide rods 124 and the positioning support structure 120. Note that the housing 82 has been omitted to allow one to view internal structures and features of the extensible arm 80. The exemplar positioning support structure 120 is located at the second longitudinal end 86 of the extensible arm 80 and includes a series of pivot points 126a, 126b and a tensioning mechanism 128, such as a clamp, to secure the arm 80 once positioned as desired. The exemplar positioning support structure 120 allows the extensible arm 80 to be adjustably pivoted in the x- and z-direction (relative to an orthogonal frame of reference 130) and the telescoping sections 122 and one or more guide rods 124 allows adjustable extension and retraction of the extensible arm 80 in the y-direction (relative to the orthogonal frame of reference 130). The guide rods 124 are fixedly attached to one section of the plurality of telescoping sections 122 that form the telescoping conduit 123 and, when the extensible arm 80 is adjustably extended and retracted, the guide rods 124 slideably move in guide holes 132 associated with the telescoping sections 122 to provide directional guidance and support to the telescoping sections 122. Other stabilizing structures, such as support tubes 134 and connection points for the housing 82 can optionally be incorporated into the structure of the telescoping sections 122.

As previously noted, the suction applied to the outlet 22 of the applicator unit 20 draws the salt from the impact zone in the application head 26, through the telescoping conduit 123, and to the outlet 22. Additionally and as an example, a flange connection 140 and non-telescoping conduit 142 operably connects the application head 26 to the telescoping conduit 123. The application head 26, the containment hood 28, the flange connection 140 and non-telescoping conduit 142 can take any suitable shape and be at any suitable orientation and do not have to have the specific shapes and orientations depicted in FIGS. 3A and 3B as long as the impact zone and the interior volume of the application head 26 are in operable connection with the outlet 22 so that suction applied to the outlet 22 of the applicator unit 20 draws the salt from the impact zone in the application head 26, through the telescoping conduit 123, and to the outlet 22.

FIG. 4 shows a schematic perspective illustration in partial cut-away view of the exemplar arm 80 and the positioning support structure 120 shown in FIGS. 3A and 3B. In the partial cut-away view, the telescoping sections 122 and the concentric, telescoping character of the telescoping conduit 123 is more clearly visible. Also visible are slide bearings 136 associated with the concentrically arranged sections of the telescoping conduit 123 and a partial cross-sectional view through the non-telescoping conduit 142.

The supply line 32 for the salt (not shown in FIG. 4) is, in some embodiments, external to the exemplar arm 80 (see, e.g., FIGS. 1 and 2) and can be, for example, a tube connecting the salt storage tank in the launch unit 24 to an entrance point of the application head 26. The supply line 32 provides salts to the application head 26 at a desired pressure and volume.

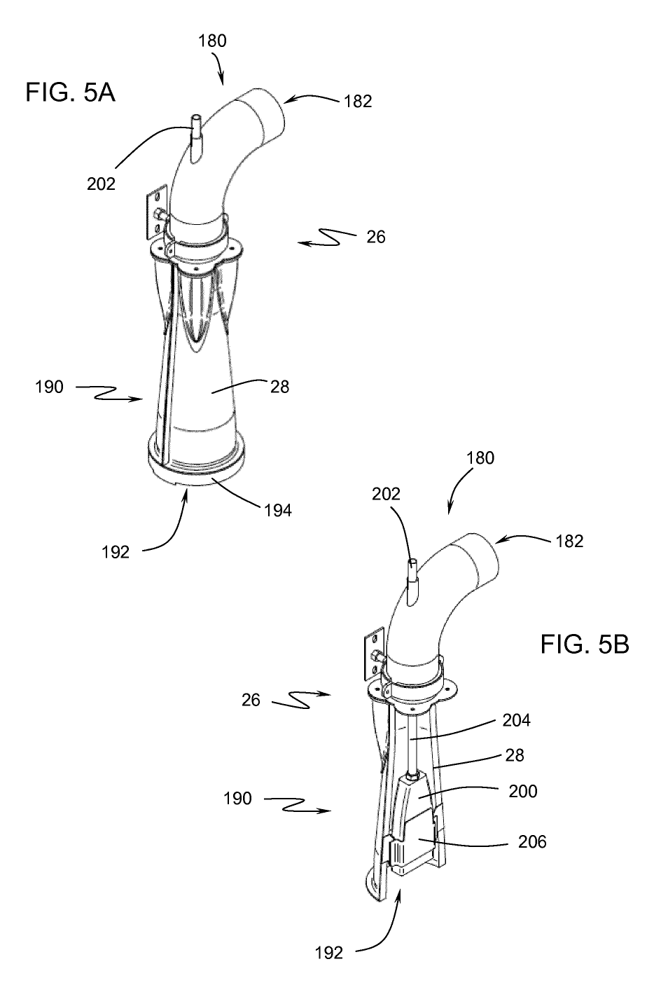

FIGS. 5A and 5B show an exemplar first embodiment of an application head 26 in perspective view (FIG. 5A) and partial cut-away perspective view (FIG. 5B). At a base end 180 of the application head 26, there is an opening 182 for connecting to the opening to the telescoping conduit 123 or non-telescoping conduit 142 at the first longitudinal end 84 of the arm 80. Via the opening 182, the base end 180 is in fluid connection with the outlet 22 at a second longitudinal end 86 of the arm 80 via a passage formed by the telescoping conduit 123 and, through the second hose or tubing 48, to the filter unit 40. At a distal end 190 of the application head 26, there is a containment hood 28 with an opening 192 through which the salt from the discharge manifold 200 can exit and impact the surface to be cleaned in an impact zone. A pliable seal 194, such as rubber gasket, provides a seal with the surface to be cleaned and facilitates the creation of a suction within the containment hood 28 so that discharged salt can be collected and moved to the filter unit 40 via the telescoping conduit 123 of the arm 80. The pliable seal 194 also provides cushioning contact between the containment hood 28 and the surface to be cleaned so as to minimize or prevent damage to the respective structures. The pliable seal 194 is positioned on a surface of the distal end 190 of the containment hood 28 and around at least a portion of the opening 192. The base end 180 of the application head 26 also includes a penetration 202 through the application head 26 to operably connect the supply line 32 (not shown) to the discharge manifold 200, either directly or with a further conduit 204 internal to the containment hood 28. The discharge manifold 200 is held in place within the internal volume of the containment hood 28 with a brace 206 or other suitable mounting structure.

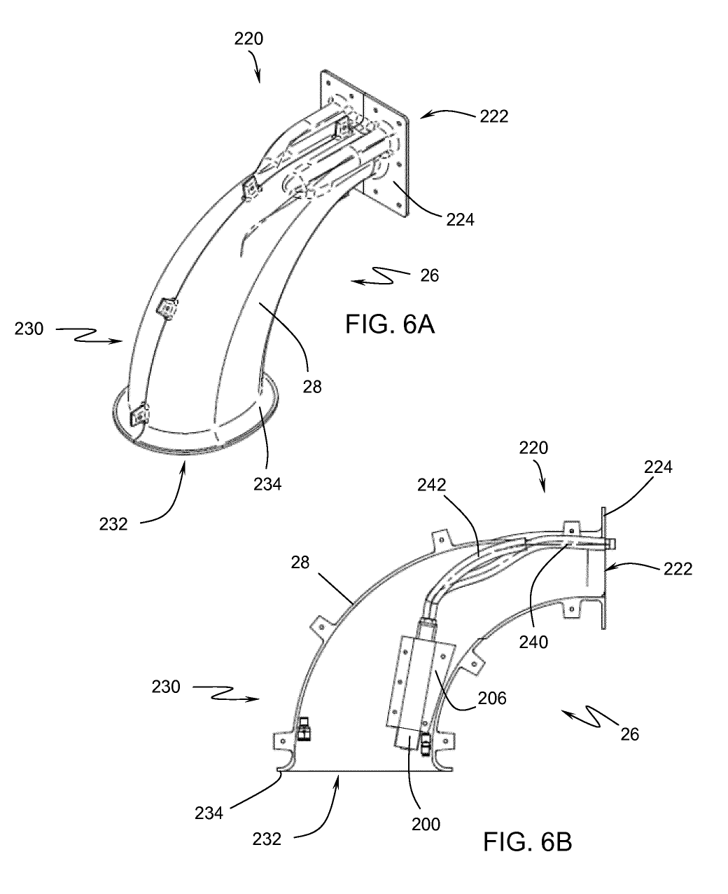

FIGS. 6A and 6B show an exemplar second embodiment of an application head 26 in perspective view (FIG. 6A) and partial cut-away side view (FIG. 6B). At a base end 220 of the application head 26, there is an opening 222 and a flange 224 for connecting the opening to the telescoping conduit 123 or non-telescoping conduit 142 and the flange connection 140 at the first longitudinal end 84 of the arm 80. Via the opening 222, the base end 220 is in fluid connection with the outlet 22 at a second longitudinal end 86 of the arm 80 via a passage formed by the telescoping conduit 123 and, through the second hose or tubing 48, to the filter unit 40. At a distal end 230 of the application head 26, there is a containment hood 28 with an opening 232 through which the salt from the discharge manifold 200 can exit and impact the surface to be cleaned in an impact zone. The flared edges 234 of the opening 232 contributes to providing a seal with the surface to be cleaned and facilitates the creation of a suction within the containment hood 28 so that discharged salt can be collected and moved to the filter unit 40 via the telescoping conduit 123 of the arm 80. Optionally, a pliable seal (like the pliable seal 194 shown and described in connection with the first embodiment of an application head 26 in FIGS. 5A and 5B) can be included in the second embodiment of an application head 26. The base end 220 of the application head 26 also includes a supply line 240 that is accessible via the opening 220 or that extends outwardly from the opening 220 to operably connect the supply line 32 (not shown) to the discharge manifold 200, either directly or with a further conduit 242 internal to the containment hood 28. The discharge manifold 200 is held in place within the internal volume of the containment hood 28 with a brace 206 or other suitable mounting structure.

When assembled in either the exemplar first embodiment or second embodiment of an application head 26, the discharge manifold 200 is supplied with the salt composition via penetration 202 and supply line 204 by a suitable conduit or tube between penetration 202 and the supply line 32 such that at least a portion of the supply line 32, e.g., the suitable conduit or tube attached to penetration 202, is externally mounted to the extensible arm 80. It is an alternative to have all of the supply line external to the arm 80 or internal to the arm 80.

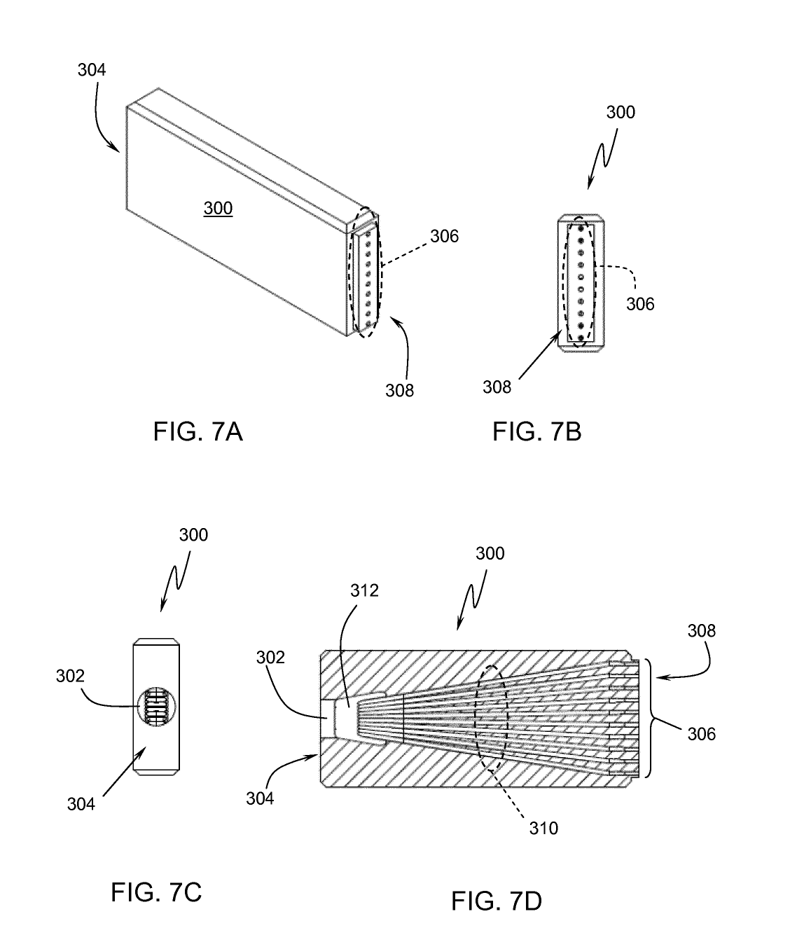

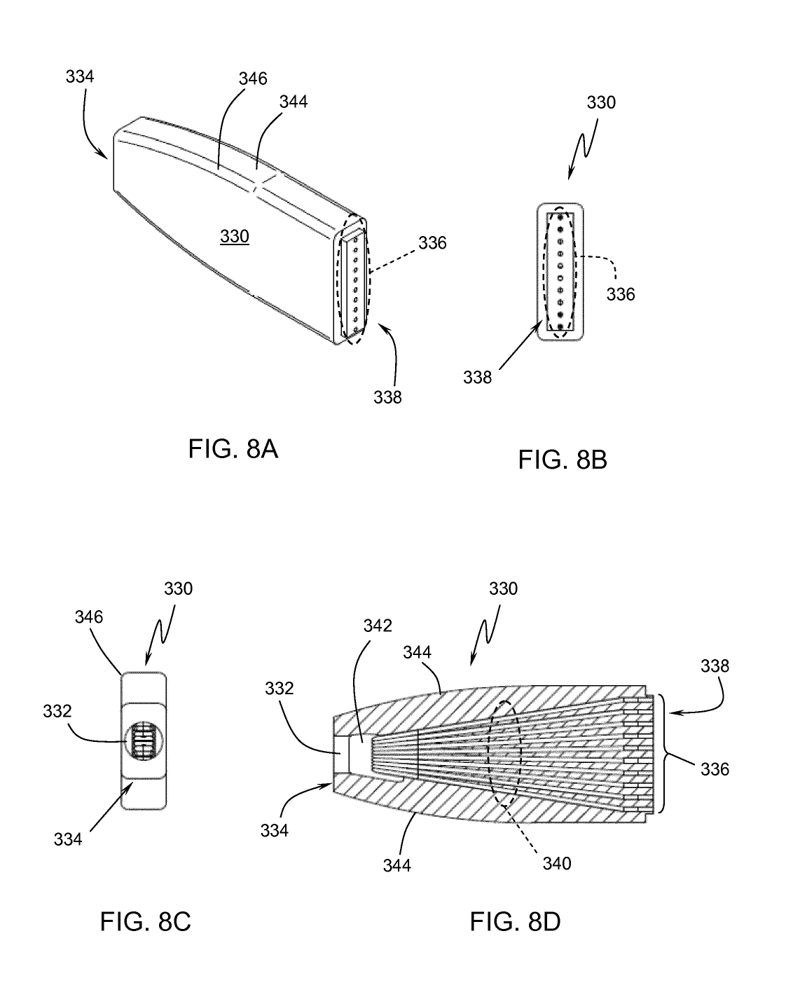

The discharge manifold in either one or both of the exemplar first embodiment and exemplar second embodiment of an application head can have any suitable form or shape and arrangement of inlet(s), outlet(s) and internal arrangement(s) that provide a pathway to convey a salt composition from the supply line to kinetically impinge the surface to be cleaned with the salt particles. FIGS. 7A to 7D and 8A to 8D illustrate two example discharge manifolds. Either of the depicted discharge manifolds can be used in any of the application heads disclosed and described herein.

FIGS. 7A to 7D are schematic illustrations of an exemplar first discharge manifold showing a perspective side view (FIG. 7A), a cut-away side view (FIG. 7B), an inlet end view (FIG. 7C) and discharge end view (FIG. 7D). The exemplar first discharge manifold 300 includes an inlet 302 at a first end 304, an array of discharge ports 306 at a second end 308, and a plurality of discharge lines 310 that operably connect the inlet 302 to the array of discharge ports 306 to allow a salt composition supplied to the inlet 302 from the supply line 32 to be conveyed to the discharge ports 306 to be kinetically impinged on the surface to be cleaned. The inlet 302 opens into a chamber 312 that provides a pathway for the salt composition between the inlet 302 and the individual discharge lines 310. In some embodiments, the chamber 312 is a common plenum to all of the discharge lines 310; in other embodiments, the chamber 312 can be divided into separate plenums that are associated with subsets of the discharge lines 310.

FIGS. 8A to 8D are schematic illustrations of an exemplar second discharge manifold showing a perspective side view (FIG. 8A), a cut-away side view (FIG. 8B), an inlet end view (FIG. 8C) and discharge end view (FIG. 8D). The exemplar second discharge manifold 330 includes an inlet 332 at a first end 334, an array of discharge ports 336 at a second end 338, and a plurality of discharge lines 330 that operably connect the inlet 332 to the array of discharge ports 336 to allow a salt composition supplied to the inlet 332 from the supply line 32 to be conveyed to the discharge ports 336 to be kinetically impinged on the surface to be cleaned. The inlet 332 opens into a chamber 342 that provides a pathway for the salt composition between the inlet 332 and the individual discharge lines 340. In some embodiments, the chamber 342 is a common plenum to all of the discharge lines 340; in other embodiments, the chamber 342 can be divided into separate plenums that are associated with subsets of the discharge lines 340.

The overall shape of the exemplar first discharge manifold 300 is a equiangular polygon block, i.e., with edge surfaces meeting adjacent edge surfaces at the same angle, preferably 90 degree angles, to form corners. An example is an equiangular rectangle. The overall shape of the exemplar second discharge manifold 330 is also generally rectangular, but the generally rectangular shape of the second discharge manifold 330 includes one or more curved edge surfaces 344 and at least some corners 346 are rounded. Alternatively or additionally, any of the discharge manifolds can include beveled corners, such as those shown in FIGS. 7A to 7D.

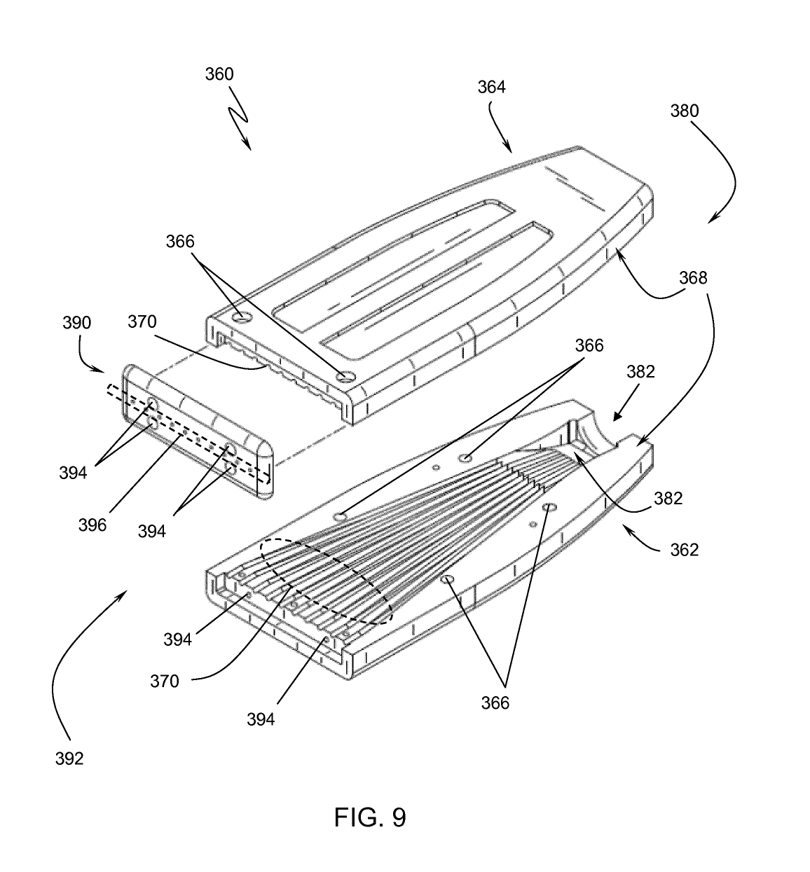

FIG. 9 is an exploded perspective view of an exemplary embodiment of a discharge manifold 360. The discharge manifold 360 includes a first base structure 362 and a second base structure 364, which can be joined together, for example by fasteners in conjunction with fastener holes 366, to form a body of the discharge manifold 360. A surface 368 of at least one, alternatively both, the first base structure 362 and a second base structure 364 includes a plurality of grooves or channels 370 that become enclosed in the joined together state to form individual discharge lines, such as the individual discharge lines 310, 340 illustrated in FIGS. 7D and 8D.

The discharge manifold 360 also includes an inlet at a first end 380. The inlet can be in one or the other of the first base structure 362 and a second base structure 364 or, as shown in FIG. 9, can be formed by the mating of partial openings 382 in one or both of the first base structure 362 and a second base structure 364 when the discharge manifold 360 is in the joined together state. The inlet leads to a volume 384 that forms a chamber when the discharge manifold 360 is in the joined together state, such as chamber 312, 342 illustrated in FIGS. 7D and 8D. The discharge manifold 360 also includes a plate 390 that is positioned at the second end 392 of the discharge manifold 360. The plate 390 can be attached to the discharge manifold 360, for example by fasteners in conjunction with fastener holes 394, or can be restrained by grooving or other retainer feature at the second end of the first base structure 362 and a second base structure 364 and sized to go over edge portions of the plate 390 when the discharge manifold 360 is in the joined together state. The plate 390 includes a plurality of discharge ports 396. The discharge ports 396 can have different designs including one or more of different locations, arrangements and sizes of the individual ports, as well as can be made from different materials.

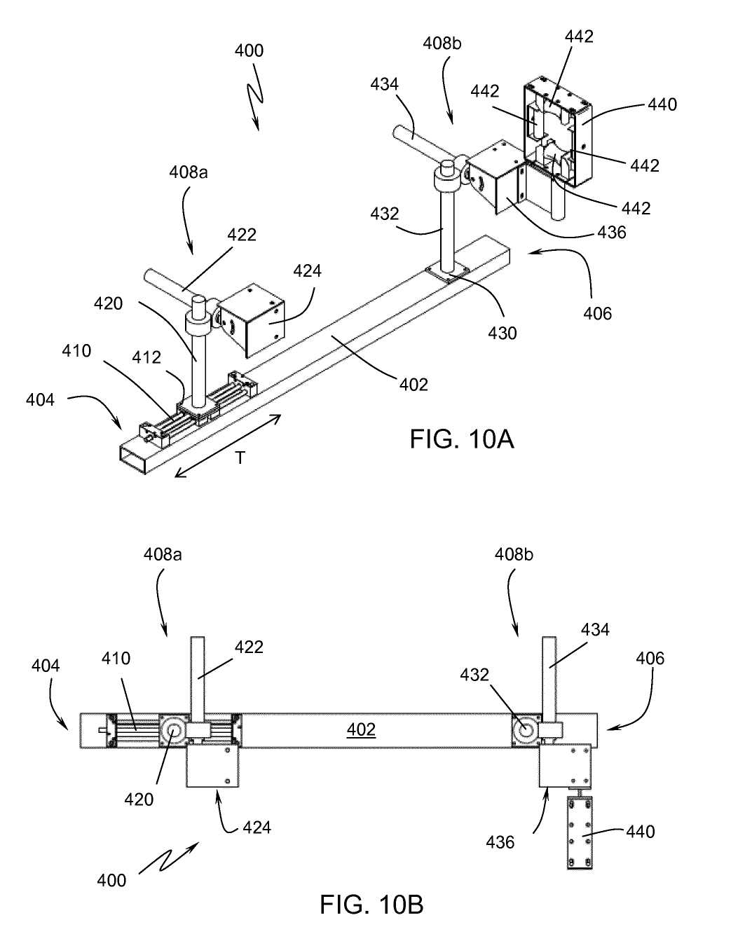

FIGS. 10A and 10B are schematic illustrations of another positioning support structure for an extensible arm showing a perspective view (FIG. 10A) and a top view (FIG. 10B). The positioning support structure 400 includes a guide arm support base 402 which extends longitudinally between a first end 404 and a second end 406. In the illustrated embodiment, the positioning support structure 400 includes two mounting structures 408a, 408b.

A first mounting structure 408a is slideably mounted to guide rails 410 located toward the first end 404 of the guide arm support base 402. The base 412 of the first mounting structure 408a interfaces with the guide rails 410 to allow longitudinally translation (T), i.e., in the longitudinal direction of the guide arm support base 402. For example, the guide rails 410 can pass through guide holes in the base 412. A clamp, detent, fastener or similar structure can be used to fix the base 412 relative to the guide rails 410 after the first mounting structure 408a has been positioned in a desired location. Attached to the base 412 is a mounting tower including a first tube 420 and a second tube 422. The first tube 420 is secured to the base 412 and the second tube 422 is slideably mounted to the first tube 420 for adjustment of the height of the mounting plate 424 relative to the guide arm support base 402.

A second mounting structure 408b is fixedly mounted toward the second end 406 of the guide arm support base 402, for example by fasteners securing a base 430 to the guide arm support base 402. Attached to the base 430 is a mounting tower including a first tube 432 and a second tube 434. The first tube 432 is secured to the base 430 and the second tube 434 is slideably mounted to the first tube 432 for adjustment of the height of the mounting plate 436 relative to the guide arm support base 402. Fixedly mounted to the mounting plate 436, e.g., with a fastener, is an arm support unit 440 that includes a plurality of rotatable bearings 442, preferably axially rotatable bearings. Alternatively, the second mounting structure 408b can be slideably mounted toward the second end 406 of the guide arm support base 402 in a manner similar to that for the first mounting structure 408a.

Although described as tubes, the use of the term “tube” is not intended to limit the actual physical shape of that feature and any shape can be used in the first and second mounting structures 408a, 408b that allows for slideable mounting and for adjustment of the height of the mounting plate relative to the guide arm support base 402.

A telescoping or non-telescoping conduit (or sections 122 forming such features), for example a tube or a structure similar to telescoping conduit 123 or non-telescoping conduit 142 previously described, can be positioned in the arm support unit 440 and fixedly mounted to the mounting plate 424 of the first mounting structure 408a. When so mounted, the rotatable bearings 442 allow movement of the telescoping or non-telescoping conduit relative to the second mounting structure 408b in conjunction with the translational movement of the telescoping conduit 123 or non-telescoping conduit 142 as the telescoping conduit 123 or non-telescoping conduit 142 (or sections 122 forming such features) moves with the translational movement (T) of the first mounting structure 408a.

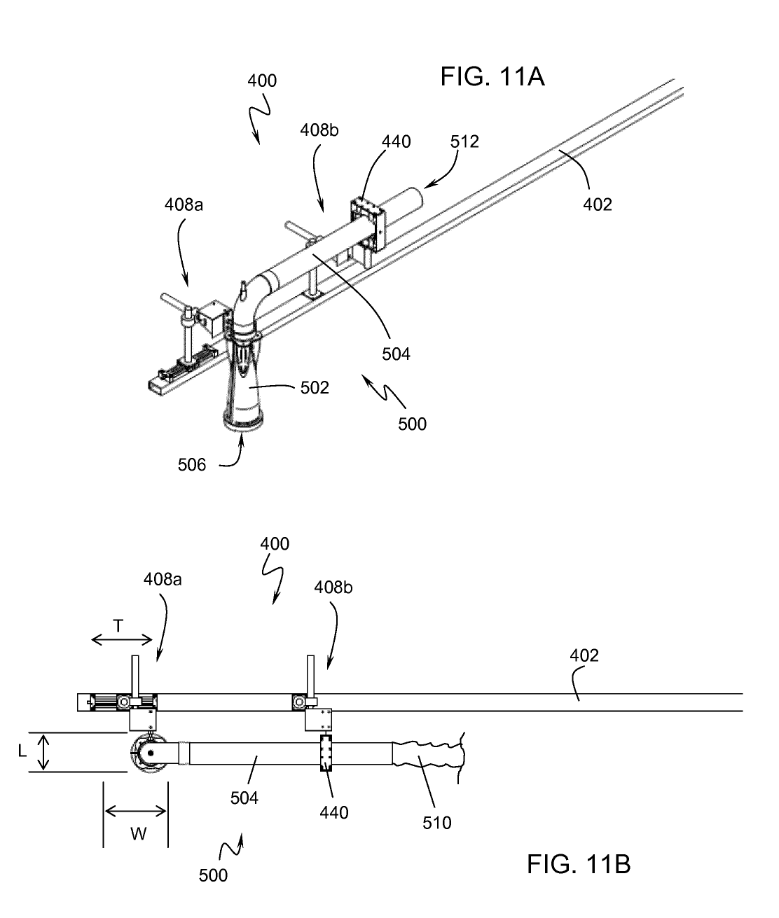

An example of an arm mounted in the positioning support structure is shown in FIGS. 11A and 11B, which are schematic illustrations of the exemplar positioning support structure 400 from FIGS. 10A and 10B with an arm 500 showing an application head 502 and a portion of the return line 504 mounted therein in a perspective view (FIG. 11A) and a top view (FIG. 11B). The arm 500, application head 502 and return line 504 can be the same or similar to those described herein, for example in conjunction with FIGS. 1 to 8A-D. The arm 500 can be translated (T) in a manner that utilizes the slideable mounting of the first mounting structure 408a and the fixed mounting and the arm support unit 440 of the second mounting structure 408. Such translation (T) extends the opening 506 of the application head 502 across a cleaning width (W) and a cleaning length (L). Because the cleaning zone is based on the opening 506 of the application head 502, the cleaning width (W) and cleaning length (L) defines the extent of the surface to be cleaned that can be serviced by a cleaning system. As a surface to be cleaned moves relative to this zone by, for example, movement of the conveyor, baking surface or heating surface of the food processing equipment (see movement (M) in FIG. 2), additional surfaces are positioned in the cleaning zone below the opening 506 and can be serviced by the cleaning system.

In FIGS. 11A and 11B, the return line 504, e.g., the conduit, is non-telescoping. To allow translation (T) of the return line 504, a flexible hose or tube 510 can be operably connected to the end 512 of the return line 504 (See FIG. 11B). A distal end of the flexible hose or tube 510 can be operably connected to extend to the filter unit 40 of the cleaning system 10 to apply a suction created by the vacuum unit 60 to the return line 504 for drawing the salt applied by the applicator unit 20 through the return line 504 and into the filter unit 40.

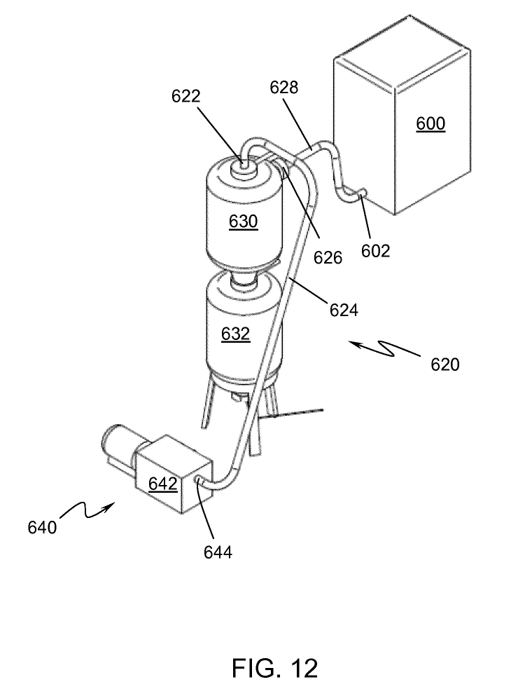

FIG. 12 is a schematic illustration of a perspective view of an alternative embodiment of an applicator unit 600, a filter unit 620 and a vacuum unit 640. FIG. 12 shows an example arrangement of these components of a cleaning system in which a first outlet 622 of the filter unit 620 is operably connected by a first hose or tubing 624 to an inlet 644 of the vacuum unit 640 and an inlet 626 of the filter unit 620 is operably connected by a second hose or tubing 628 to an outlet 602 of the applicator unit 600.

The vacuum unit 640 includes a vacuum motor 642 (or similar device) that creates a suction that is applied through the first hose or tubing 624 to draw the filtered air from the filter unit 620. Air, salts and residues drawn from unit 600 through pipe 628 enter the filter unit 620 where filters located in 630 separate the solid parts (salts and residues) from the air. Internally to the filter unit 620, the outlet 622 is separated from the inlet 626 by a tortuous path or a mechanical filter that allows the atmosphere to be drawn through the first hose or tubing 624 to an inlet 644 of vacuum unit 640 while salt entrained in the flow of the atmosphere is removed from the atmosphere and is collected, typically assisted by gravity, into the collecting tank 632.

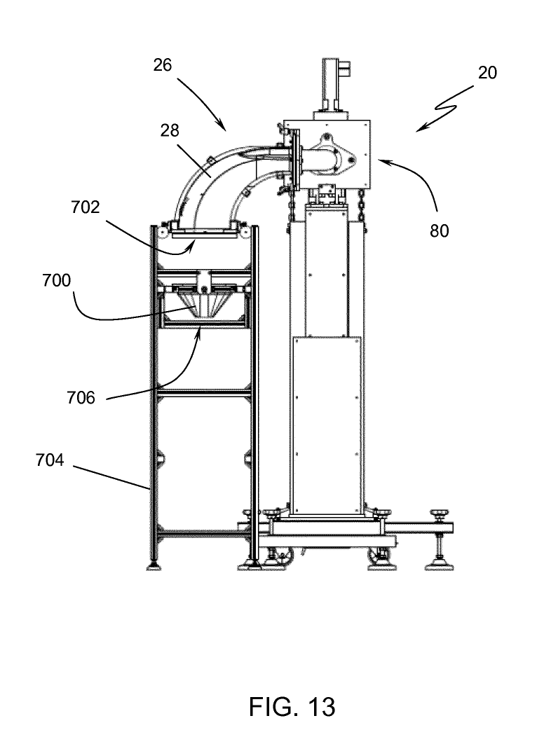

As already discussed, when non-solid surfaces, like perforated belts or wire-mesh belts, are cleaned, nominally one third of salts and residues are collected from the top of the surface by the vacuum action of the vacuum unit 60 and nominally two thirds are collected by suitable means, e.g., by a collection trough below the surface to be cleaned. FIG. 13 is a schematic, side elevation view of an exemplar applicator unit 20 of a cleaning system showing the arrangement of a suitable collection means. Suitable collection means can be a trough, funnel basin, bucket or other similar device that can hold salts and residues from the cleaning process. In the illustrated example, the collection means 700 is a trough. The collection means 700 is positioned below and spaced apart from the opening 702 in the containment hood 28. This spaced apart relationship accommodates positioning of the surface to be cleaned in the impact zone below the opening 702. The collection means 700 sits on a support system 704, such as frame. The collection means 700 can include an opening 706 in a bottom surface to accommodate connection of the collection means 700 to a conduit or other device (not shown) by which material collected in the collection means 700, such as used salt composition and residues from cleaning, is removed or conveyed from the collection means 700 to be processed, disposed or recycled.

The cleaning systems disclosed herein can be used for continuous and automatic cleaning of food-related equipment—like, but not limited to, conveyors, freezers, dryers, bake ovens, coolers, steam cookers, and surfaces such as, but not limited to, solid belts, perforated belts, wire-mesh belts and plates—by one or more of kinetic impingement of and chemical reaction with particles having a composition including one or more of sodium bicarbonate, sodium carbonate and calcium phosphate in a dry cleaning process, i.e., a process that does not include a separate liquid component. For example, the arm of the applicator unit can be positioned with the opening in the distal end of the containment hood of the application head over the surface to be cleaned. Positioning can include one or more of translating the telescoping sections, translating the non-telescoping conduit, and pivoting the positioning support structure so that the desired surface to be cleaned is located within an impact zone of the salt exiting the array of discharge ports of the discharge manifold. The applicator unit then sends salt through a supply line to the discharge manifold. The discharged salt impinges the surface to be cleaned in an impact zone and the surface is cleaned by a combination of the kinetic energy of the salt particles and by the chemical reaction of the salt with any foreign material, such as food residue, present on the surface. The impact zone is sealed by the position of the surface of the distal end of the containment hood (with or without a pliable seal) relative to the surface of the food-related equipment and surface. Either the impact zone or the food-related equipment and surfaces can be moved relative to each (e.g., the applicator arm can be moved, for example by translating or pivoting, or the surface to be cleaned can be moved, for example by moving a conveyor surface) so that the surface to be cleaned can be varied. The discharged salt is then recovered by a suction applied to the interior volume of the containment hood that draws the discharged salt through the telescoping or non-telescoping conduit and to the filter unit.

Although the present invention has been described in connection with embodiments thereof, it will be appreciated by those skilled in the art that additions, deletions, modifications, and substitutions not specifically described may be made without departure from the spirit and scope of the invention as defined in the appended claims.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A cleaning system to mechanically impact a surface with a plurality of salt particles, comprising:
an applicator unit;
a filter unit; and
a vacuum unit,
wherein the applicator unit includes a modular arm unit with an extensible arm and a buffer unit,
wherein the extensible arm includes a plurality of sections forming a telescoping conduit, an application head at a first longitudinal end of the arm, and an outlet at a second longitudinal end of the arm for operable connection to the filter unit,
wherein sections of the telescoping conduit are translatable relative to the second longitudinal end in a longitudinal direction along a guide arm,
wherein the application head includes a containment hood enclosing an interior volume and having a base end in operable connection with the outlet at the second longitudinal end of the arm via a passage including the telescoping conduit, a distal end having an opening to the interior volume, and a discharge manifold having an inlet port at an inlet end in operable connection to a storage volume for the plurality of salt particles, an array of discharge ports at a discharge end, and a plurality of discharge lines in operable communication with the inlet port and the array of discharge ports, and
wherein the applicator unit, the filter unit, and the vacuum unit are connectable to draw the plurality of salt particles exiting the discharge manifold of the application head of the applicator unit to the filter unit.

2. The cleaning system of claim 1, wherein the plurality of salt particles have a composition that includes one or more of sodium carbonate (Na₂CO₃), sodium bicarbonate (NaHCO₃), monocalcium phosphate (Ca(H₂PO₄)₂), dicalcium phosphate (CaHPO₄) and tricalcium phosphate (Ca₃(PO₄)₂)).

3. The cleaning system according to claim 1, wherein the cleaning system is a dry environment.

4. The cleaning system according to claim 1, wherein the plurality of salt particles exiting the discharge manifold does not include a liquid component.

5. The cleaning system according to claim 1, wherein a supply line operably connects the storage volume to the discharge manifold, wherein the telescoping conduit forms at least a portion of a return line operably connecting the interior volume of the containment hood to the outlet at the second longitudinal end of the arm, and wherein at least a portion the telescoping conduit circumscribes at least a portion of the length of the supply line.

6. The cleaning system according to claim 1, wherein the applicator unit includes a launch unit that includes a connection for connecting compressed air to the storage volume for the plurality of salt particles.

7. The cleaning system of claim 6, wherein the applicator unit includes a positioning support structure, and wherein a position of the extensible arm relative to a launch unit is adjustable using the positioning support structure.

8. The cleaning system according to claim 1, wherein a plurality of guide rods are fixedly attached to one of the plurality of sections forming the telescoping conduit and slideably moves in guide holes associated with other of the plurality of sections forming the telescoping conduits.

9. The cleaning system according to claim 5, wherein at least a portion of the length of the supply line along a length of the arm is located external to the arm.

10. The cleaning system according to claim 9, wherein an entire length of the supply line along a length of the arm is located external to the arm.

11. The cleaning system according to claim 1, wherein a pliable seal is positioned on a surface of the distal end of the containment hood.

12. The cleaning system as in according to claim 1, wherein the distal end of the containment hood has flared edges.

13. The cleaning system according to claim 1, wherein the cleaning system is an open loop system.

14. The cleaning system according to claim 1, wherein the applicator unit, the filter unit, and the vacuum unit are connectable by a plurality of connecting hoses.

15. A cleaning system to mechanically impact a surface with a plurality of salt particles, comprising:
an applicator unit;
a filter unit; and
a vacuum unit,
wherein the applicator unit includes a positioning support structure including an arm with a conduit connecting an application head at a first longitudinal end of the arm to an outlet at a second longitudinal end of the arm for operable connection to the filter unit,
wherein the arm is supported on a guide arm support base by a plurality of mounting structures and is longitudinally translatable relative to the guide arm support base,
wherein the application head includes a containment hood enclosing an interior volume and having a base end in operable connection with the conduit, a distal end having an opening to the interior volume, and a discharge manifold having an inlet port at an inlet end in operable connection to a storage volume for the plurality of salt particles, an array of discharge ports at a discharge end, and a plurality of discharge lines in operable communication with the inlet port and the array of discharge ports, and
wherein the applicator unit, the filter unit, and the vacuum unit are attachable to draw the plurality of salt particles exiting the discharge manifold of the application head of the applicator unit to the filter unit.

16. The cleaning system of claim 15, wherein the plurality of salt particles have a composition that includes one or more of sodium carbonate (Na₂CO₃), sodium bicarbonate (NaHCO₃), monocalcium phosphate (Ca(H₂PO₄)₂), dicalcium phosphate (CaHPO₄) and tricalcium phosphate (Ca₃(PO₄)₂)).

17. The cleaning system according to claim 15, wherein the cleaning system is a dry environment.

18. The cleaning system according to claim 15, wherein the plurality of salt particles exiting the discharge manifold does not include a liquid component.

19. The cleaning system according to claim 15, wherein the applicator unit includes a launch unit that includes a connection for connecting compressed air to the storage volume for the plurality of salt particles.

20. The cleaning system according to claim 15, wherein a pliable seal is positioned on a surface of the distal end of the containment hood.

21. The cleaning system according to claim 15, wherein the distal end of the containment hood has flared edges.

22. The cleaning system according to claim 15, wherein the cleaning system is an open loop system.

23. A method of cleaning a surface of food-related equipment with the cleaning system according to claim 7, the method comprising:
positioning the arm of the applicator unit to locate the opening in the distal end of the containment hood of the application head over the surface of food-related equipment to be cleaned, wherein positioning includes one or more of translating the telescoping sections, translating the non-telescoping conduit, and pivoting the positioning support structure so that the surface to be cleaned is located within an impact zone of the salt exiting the array of discharge ports of the discharge manifold;
sealing the impact zone by positioning the surface of the distal end of the containment hood relative to the surface to be cleaned so that a suction can be drawn on an interior volume of the containment hood;
sending salt through the supply line to the discharge manifold;
discharging salt from the discharge manifold to impinge the surface to be cleaned located in the impact zone; and
collecting the discharged salt in the filter unit by applying a suction to the interior volume of the containment hood to draw the discharged salt through the telescoping or non-telescoping conduit and to the filter unit.

24. The method of claim 23, further comprising varying the surface to be cleaned by moving the impact zone relative to the surface of the food-related equipment.

25. The method of claim 24, wherein moving the impact zone relative to the surface of the food-related equipment includes one or more of (a) translating the applicator arm, (b) pivoting the applicator arm, (c) operating a conveyor belt system to move the surface of the food-related equipment.

26. The method according to claim 23, wherein a combination of a kinetic energy of the salt particles and a chemical reaction of the salt with foreign material cleans the surface to be cleaned.

27. The method of claim 26, wherein the foreign material is food residue present on the surface to be cleaned.

28. The method of claim 27, wherein the food-related equipment is a conveyor, a freezer, a dryer, a baking oven, a cooler, or a steam cooker.

29. The method of claim 23, wherein the surface of food-related equipment is associated with a solid belt, a perforated belt, a wire-mesh belt or a plate.

30. The method according to claim 23, wherein the plurality of salt particles have a composition that includes one or more of sodium carbonate (Na₂CO₃), sodium bicarbonate (NaHCO₃), monocalcium phosphate (Ca(H₂PO₄)₂), dicalcium phosphate (CaHPO₄) and tricalcium phosphate (Ca₃(PO₄)₂)).

31. The method according to claim 30, wherein the cleaning system is a dry environment.

32. The method according to claim 30, wherein the plurality of salt particles exiting the discharge manifold does not include a liquid component.

33. The method according to claim 23, comprising:
positioning a collection means below and spaced apart from the opening in the distal end of the containment hood of the application head; and
one or more of (a) collecting at least a portion of the discharged salt in the collection means, and (b) conveying the collected discharged salt away from the collection means to process, dispose or recycle the discharged salt.

34. A method of cleaning a surface of food-related equipment with the cleaning system according to claim 15, the method comprising:
positioning the arm of the applicator unit to locate the opening in the distal end of the containment hood of the application head over the surface of food-related equipment to be cleaned, wherein positioning includes one or more of translating the telescoping sections, translating the non-telescoping conduit, and pivoting the positioning support structure so that the surface to be cleaned is located within an impact zone of the salt exiting the array of discharge ports of the discharge manifold;
sealing the impact zone by positioning the surface of the distal end of the containment hood relative to the surface to be cleaned so that a suction can be drawn on an interior volume of the containment hood;
sending salt through the supply line to the discharge manifold;
discharging salt from the discharge manifold to impinge the surface to be cleaned located in the impact zone; and
collecting the discharged salt in the filter unit by applying a suction to the interior volume of the containment hood to draw the discharged salt through the telescoping or non-telescoping conduit and to the filter unit.
